(19) United States
(12) Patent Application Publication
(10) Pub. No.: US 2007/0221847 A1
(43) Pub. Date: Sep. 27, 2007

(54) Illumination Method and Apparatus

(75) Inventors: Alan H. Lettington, Berkshire (GB); Brenda Lettington, Berkshire (GB)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FARRAN TECHNOLOGY LIMITED, COUNTY CORK (IE)

(21) Appl. No.: 10/587,985

(22) PCT Filed: Jan. 21, 2005
(86) PCT No.: PCT/GB05/00239

§ 371 Date: Jan. 12, 2007

(30) Foreign Application Priority Data
Jan. 22, 2004 (GB) 0401389.2

(51) Int. Cl. G02F 1/00

(52) U.S. Cl. 250/330

(57) ABSTRACT

Imaging apparatus is disclosed for passive microwave, millimetre wave, sub-millimetre wave or infrared imaging, the apparatus including a receiver (10) for receiving radiation from the scene or subject being imaged, means for directing such radiation onto the receiver, a cold source (16) or a hot source (16), i.e. a source with a low or high black body temperature, and means (14, 14a) for directing the image or shadow of said cold source or hot source onto the scene or subject being imaged. The result is to produce improved contrast in the image obtained. Imaging apparatus is also disclosed for imaging an object (102) in the microwave, millimetre wave, sub-millimetre wave or infrared ranges in which a retroreflector such as a cube-corner reflective array (104) is arranged facing the object and disposed laterally with respect of the line of sight between the object and an imaging device (100) and in which such radiation is directed onto the object, from a radiation source, along a path corresponding to or close to that line of sight. Consequently light from the radiation source, reflected laterally from the object, will be reflected, in turn, by the cube-corner array, back substantially along the path which it followed from the object to the cube-corner array, to be reflected in turn, by the object, back to the imaging device. The apparatus therefore ensures that specularly reflective parts of the object (102) appear bright in the resulting image.

THIS INVENTION relates to microwave, millimetre wave, sub-millimetre wave or infrared imaging systems, such as, for example, the systems proposed by the inventor in WO03/012524 or WO03/075554.

Passive mm-wave imaging has the potential for detecting concealed weapons because clothing is in general transparent and metal objects have a high reflectivity (˜100%), particularly when compared with the reflectivity of skin which is of the order of 50%.

Clouds are largely transparent in the mm-wave region and the sky temperature is close to that of liquid nitrogen (100K). Highly reflective objects tend to reflect this cold sky while highly emissive objects radiate at their black body temperature (˜300K). Thus there is a 200K temperature difference between apparent temperature of a highly reflective surface and a highly emissive surface.

This difference in apparent temperature provides a contrast in a mm-wave image, which can be used to detect concealed metal and dielectric objects.

Frequently observers would like to detect concealed weapons on a person when that person is inside a building or in a confined space where cold sky reflections are not possible or are restricted and where ambient illumination of the subject being scanned is provided by surfaces which may be at a temperature much closer to, or even higher than, say, the body temperature of a human subject being scanned, so that contrast in the, resulting image is much reduced.

It is an object of the present invention to provide a solution to the above-noted problem.

According to one aspect of the invention, there is provided a method of illuminating subjects to be imaged by a microwave, millimetre wave or infrared passive imaging system, comprising directing, onto the subject to be imaged, the image or shadow, as herein defined, of a cold source, i.e. a source with a low black body temperature, or of a hot source, i.e. a source with a black body temperature significantly higher than that of the subject to be imaged.

According to another aspect of the invention there is provided imaging apparatus for passive microwave, millimetre wave or infrared imaging, including a receiver for microwave, millimetre wave or infrared radiation from the scene or subject being imaged, directing means for directing such radiation onto the receiver, a cold source or a hot source, i.e. a source with a low or high black body temperature, and means for directing the image or shadow, as herein defined, of said cold source or hot source onto the scene or subject being imaged.

In operation of the invention using a cold source, the cold source can be thought of as directing “cold” radiation onto the subject from the cold source, and the apparatus can be thought of as directing the image or shadow of the cold source onto the subject to be imaged. From another point of view, the cold source is effectively absorbing radiation emanating from the subject, without re-emitting that radiation, with the result that radiation emanating from the imaging apparatus, or from objects close to the latter, and reflected (e.g. by metal items carried by the subject) back towards the imaging apparatus, is much reduced, as compared with what would be the case if the apparent black body temperature of the imaging device corresponded to the room temperature in the building where the imaging is being carried out, so that contrast in the image is significantly improved. Arrangements in which contrast is improved in this way are herein referred to, for convenience, as arrangements in which the image or shadow of the cold source is directed to the subject or scene being scanned.

In a preferred embodiment of the invention, a cold source is used comprising a emissive body, e.g. a metal block or panel with a black surface, the block or panel being artificially cooled, e.g. by liquid nitrogen.

Alternatively, it would be possible, in accordance with the present invention, to use instead of the cold source, a hot source, i.e. an emissive body with a temperature significantly higher than the body temperature of the subject being scanned, and in which radiation from the hot source is directed onto the subject being scanned, to be substantially absorbed by, for example, the clothing and skin of the subject but to be reflected from metal objects carried on the body of the subject, such as concealed weapons etc., thereby again increasing contrast, (although in this case, of course, the metal objects will appear as being brighter, rather than darker, than the other parts of the subject in the resulting image). Thus, in this alternative arrangement it is convenient to regard the image or shadow of the hot source as being directed onto the subject or scene being scanned.

As indicated above, microwave, mm-wave and infrared imaging works well in the open when objects are able to reflect the cold sky. The imaging apparatus used in such imaging detects changes in reflectivity from point to point in the scene imaged. This situation is analogous to visible-light imaging on a bright cloudy day, except that in visible-light imaging a reflective surface may reflect radiation from the sun, while in mm-wave imaging, for example, a reflective surface in the open is likely to reflect the lack of radiation from the cold sky.

Inside a building it may be necessary to use artificial illumination for mm-wave cameras as for visible light imaging. In visible-light imaging it may be sufficient to use a single source of radiation since most surfaces of interest scatter the incident radiation. In the mm-wave region however objects in a scene being imaged tend to be more specularly reflecting, so that radiation from an illumination source does not necessarily reflect towards a nun-wave camera.

It is among the objects of the present invention, in further aspects, to provide an illuminating method and an illuminating and imaging apparatus by which the last-noted disadvantage may be avoided or mitigated.

According to one such further aspect of the invention there is provided a method of illuminating an object by radiation in the microwave, millimetre wave or infrared ranges for imaging by an imaging device, comprising arranging a retroreflector, such as a cube-corner reflective array facing the object and disposed laterally with respect of the line of sight between the object and the imaging device and directing such radiation onto the object, from a radiation source, along a path corresponding to or close to said line of sight, whereby light from said source, reflected laterally from the object, will be reflected, in turn, by the cube-corner array, back substantially along the path which it followed from the object to the cube-corner array, to be reflected in turn, by the object, back to the imaging device.

According to another such further aspect of the invention, there is provided apparatus for illuminating and imaging an object in an object area by radiation in the microwave, millimetre wave or infrared ranges, comprising an imaging device, a source of such radiation, a retroreflector such as a cube-corner reflective array arranged facing said object area and means for directing such radiation from the radiation source towards said object area along a path corresponding to the line of sight of the imaging device.

Embodiments of the invention are described below with reference to the accompanying drawing in which:

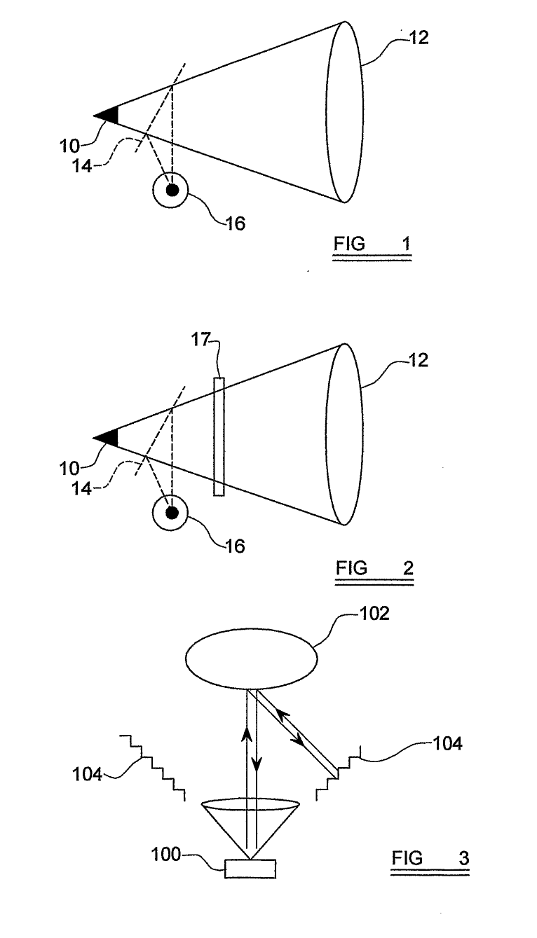

FIG. 1 is a diagrammatic side view of a receiver arrangement in a scanning apparatus according to the invention, in one of its aspects,

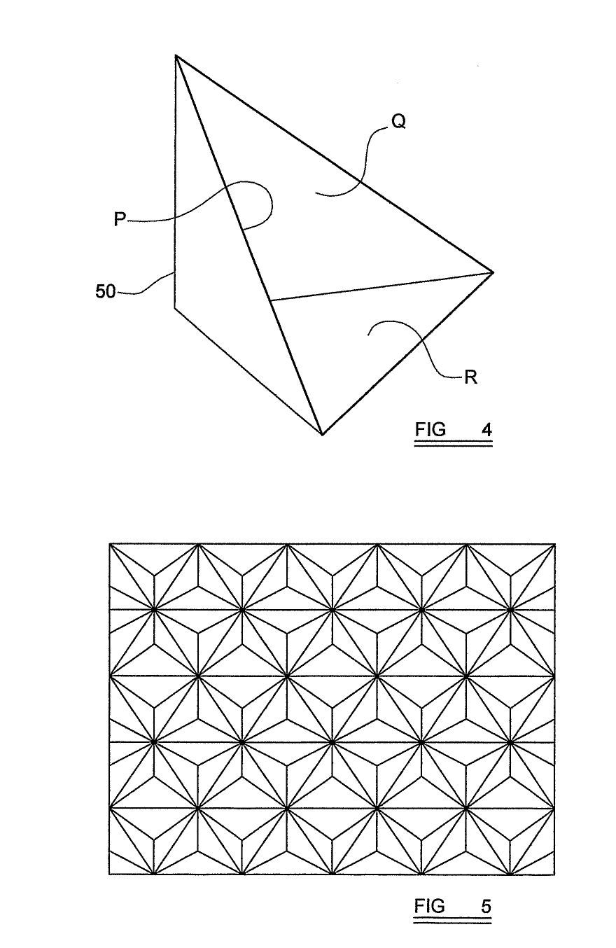

FIG. 2 is a view, similar to FIG. 1, of a (preferred) variant,

FIG. 3 is a schematic plan view of an illuminating and imaging arrangement embodying the invention in another of its aspects,

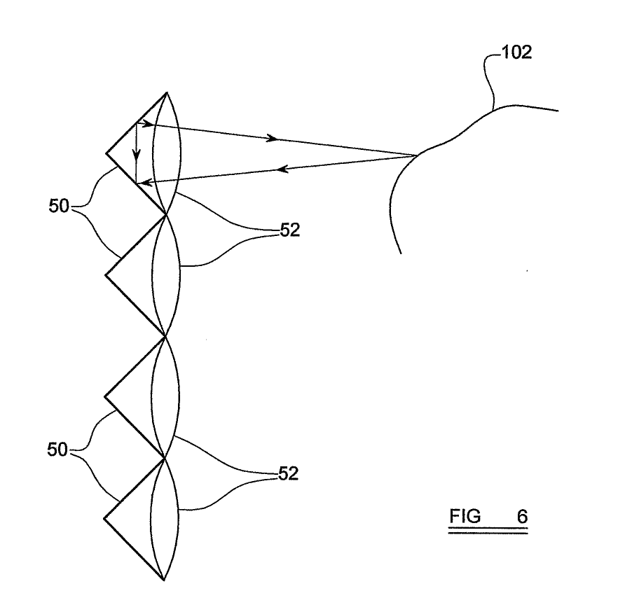

FIG. 4 is a diagrammatic perspective view of a cube corner reflector,

FIG. 5 is an elevation view of an array of cube corner reflectors,

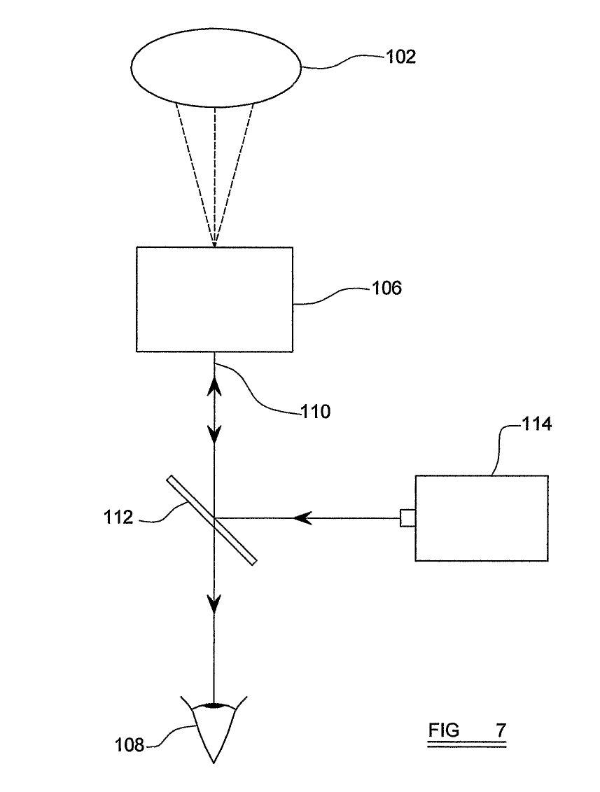

FIG. 6 is a schematic sectional view of a fragment of a variant of the retroreflector of FIGS. 4 and 5, and

FIG. 7 is a schematic view of part of one form of the apparatus of FIG. 3.

The receiver arrangement shown in FIG. 1 may be used as the radiation receiver or sensor in a scanning imaging apparatus of the kind described in WO03/012524 or WO03/075554, or where such scanning apparatus includes an array of radiation sensors or receivers, each of these may be of the form illustrated in FIG. 1.

Referring to FIG. 1, the receiver arrangement may comprise a radiation receiver, into which a cone of radiation, (indicated schematically at 12), received from the scene or subject being scanned by the scanning apparatus is directed. The receiver may, in manner known per se, incorporate a detector and a horn arranged to feed received radiation to the detector. Disposed in the path the radiation directed from the scene or subject being scanned toward the receiver 10 is a beam splitter 14, set an angle with respect of the major axis of the receiver 10 and cone 12, i.e. at an angle to the direction of incoming radiation, so as to reflect a portion of such radiation laterally to a cold source 16, the beam splitter 14 allowing the remainder of the incoming radiation to pass to the receiver 10. The cold source may, for example, comprise a metal block or plate presenting an emissive, e.g. matt black, surface towards the beam splitter and which metal block or plate is artificially cooled, e.g. by liquid nitrogen. As a result, microwave, mm-wave sub-mm-wave or infrared radiation reflected onto the source 16 is largely absorbed and very little is re-emitted towards the beam splitter 14, with the result that the black body radiation emitted towards the subject being imaged by the receiver 10 and source 16 in combination is significantly reduced as compared with the case in which the beam splitter 16 is omitted and/or the source 16 is at ambient temperature, so that reflection of such radiation, back towards the scanning apparatus by, for example, reflective, e.g. metal, items carried by a human subject is much reduced and such items appear largely “black” in the resulting image, in contrast to, e.g. areas of flesh or skin.

In the arrangement of FIG. 1, the beam splitter 14 attenuates the radiation reaching the receiver 10. In a more refined variant, illustrated in FIG. 2 and of particular utility where the receiver 10 is, as is generally the case at the wavelengths in question, sensitive to radiation plane polarised in a particular direction, the simple beam splitter 14 may be replaced by a wire grid polariser 14a and a quarter wave transmitter or reflector 17, (or alternatively a ferrite element configured as a Faraday rotator 17), may be mounted in the path of the radiation between the wire grid polariser and the subject, e.g. in the cone 12 of radiation reaching the receiver 10 from the scene or subject being scanned.

In general, the image or shadow of the cold source may be directed onto the scene or subject being imaged, and radiation from that scene or subject directed onto the receiver 10, via a conventional circulator, or via a wire grid polariser and quarter wave reflector or transmitter in combination, or via a wire grid polariser and a Faraday rotator in combination.

The cold source 16 may be replaced by a hot source, i.e. an emissive body with a temperature significantly higher than the temperature of the body being scanned or of the bodies in the scene being scanned. In this case, reflective items carried by a human subject will appear significantly lighter or brighter, in the resulting image, than areas of flesh or skin of a human subject.

The configuration described with reference to FIG. 2 will also remove or reduce the Narcissus effect encountered in conventional infra-red imaging apparatus, (where radiation which is transmitted by the receiver is reflected back from the scene, producing an erroneous image intensity). Thus, for example, under certain circumstances, in known apparatus, a low noise amplifier (LNA) in a receiver may radiate out of the associated horn. When this radiation is reflected back from the scene it produces an erroneous image intensity. This is analogous to the Narcissus effect in infra-red. The configuration illustrated in FIG. 2 will act as an isolator and remove this effect.

As indicated above, microwave, mm-wave and infrared imaging works well in the open when objects are able to reflect the cold sky. The imaging apparatus used in such imaging detects changes in reflectivity from point to point in the scene imaged. This situation is analogous to visible-light imaging on a bright cloudy day, except that in visible-light imaging a reflective surface may reflect radiation from the sun, while in mm-wave imaging, for example, a reflective surface in the open is likely to reflect the lack of radiation from the cold sky.

Inside a building it may be necessary to use artificial illumination for mm-wave cameras as for visible light imaging. In visible-light imaging it may be sufficient to use a single source of radiation since most surfaces of interest scatter the incident radiation. In the mm-wave region however objects in a scene being imaged tend to be more specularly reflecting, so that radiation from an illumination source does not necessarily reflect towards a mm-wave camera.

It is among the objects of the present invention, in further aspects, to provide an illuminating method and an illuminating and imaging apparatus by which the last-noted disadvantage may be avoided or mitigated.

It is a further object of the invention to provide an artificial environment within which active illumination from a hot or cold source is made to reflect from an object towards a mm-wave, microwave or infrared camera.

Referring to FIG. 3 of the accompanying drawings, which is a schematic plan view of an illuminating and imaging arrangement embodying the above-noted further aspects of the invention, a mm-wave imaging device 100, which may be a scanning apparatus as described in WO03/012524 or WO03/075554 is arranged facing the object or target 102 to be imaged. Thus, the scanning apparatus may comprise a plurality of radiation receivers arranged in a line, i.e. as a linear array, and the scanning apparatus may be arranged in effect to scan the image of the scene being monitored across such array in a direction perpendicular to the linear extent of the array whereby, for example, a plurality of lines of a raster scan may be generated simultaneously with each radiation receiver in the array contributing, for example, a respective sub-raster to an overall raster scan. Referring again to FIG. 3 the apparatus is arranged to direct a beam of radiation to which the imaging device 100 is sensitive from an active illumination radiation source (not shown) onto the object 102 and the imaging device is arranged to receive such radiation reflected from the object 102. As shown in FIG. 3, the radiation from the radiation source is bore sighted with the direction of view of the millimetre wave camera 100. That is to say, the arrangement is such that the radiation from the source is directed onto the object or target 102 substantially along the line of sight of the imaging device or camera 100. In the absence of the retroreflector 104 referred to below, (and assuming the imaging device or camera 100 to be of the scanning type so that, at any given instant, only a relatively small elementary part of the overall field of view defined by the scanning raster is providing input to a particular (or even the sole) radiation receiver in the imaging device), if the corresponding portion of the target being illuminated reflects the radiation back to the camera/imaging device 100 in such a way that the radiation reaches the radiation receiver, then that elementary part of the field of view will be observed well. However, if the corresponding part of the target 102 being illuminated reflects the radiation at an angle so that the reflected radiation misses the radiation receiver 100, then the corresponding part of the object or target will appear not to be illuminated. Referring again to FIG. 3, this illustrates the situation where retroreflectors 104 are provided. Thus, FIG. 3 shows a situation in which radiation from the active illumination source mounted within the camera/imaging device 100 is directed in a beam onto a spot on the target 102 and is reflected at an oblique angle from that spot towards the retroreflective structure 104. This structure reflects the radiation incident upon it from an illuminated spot on the object or target 102 back towards the originally illuminated spot on the target, from which it is reflected back again to the camera/imaging device 100, to be detected.

The reflective structure 104 may take any of several forms. For example, it may comprise a layer of transparent beads or spheres on a supporting substrate, i.e. the equivalent, at the wavelengths concerned, of the reflective glass-bead-loaded coatings used in road signs and the like. Preferably, however the retroreflective structure may consist of an array of reflective corner-cubes. A reflective corner-cube such as illustrated at 50 in FIG. 4, that is to say a reflector comprising three mutually perpendicular planar reflective faces P,Q and R which meet (from the point of view of radiation entering the reflector) in an internal corner having the same configuration as the internal corner of a hollow cube, (as shown in FIG. 4), has the property that a ray of radiation reflected by the corner-cube reflector is parallel to the direction of the incident ray before such reflection, but is laterally displaced from it. The magnitude of such lateral displacement depends upon the distance of the point in the cube-corner reflector struck by the incoming ray from the vertex of the cube-corner and the maximum of such lateral displacement thus depends upon the size of the cube-corner reflector. An array of congruent corner-cubes, as illustrated in FIG. 5, has the same property but the maximum lateral displacement of the reflected ray with respect to the incident ray is still determined by the dimensions of the individual corner-cubes in the array and not by the size of the array as such. The lateral displacement referred to above can effectively be eliminated if the size of each corner cube is comparable with or smaller than the diffraction limited spot size at the structure. Alternatively, (or additionally), such lateral displacement can be eliminated by providing respective lenses in front of the individual cube corners of the cube corner array. Thus, as illustrated in FIG. 6, the cube-corner reflective array may be modified by covering each cube-corner 50 with a respective converging lens 52, each lens 52 being preferably mounted so that its optical axis passes through the vertex of its respective cube-corner and being close to or touching the free edges of the respective cube-corner so that the cube corner array is effectively covered by a corresponding array of converging lenses 52. The focal lens of each lens 52 may be equal to or approximate to the distance of the retroreflector from the object 102 being imaged. The arrangement described above with reference to FIG. 6 improves the intensity of radiation received from the retroreflector array at a point on the object 102 being imaged. In effect, the retroreflector of FIG. 6 acts like an array of the reflective elements known as “cats eyes” used in roadway reflectors.

Where the imaging device 100 is of the scanning type, in which radiation from a relatively extended field of view is scanned raster-fashion into a stationary radiation receiver or linear array of stationary receivers as described above or as described in WO03/012524, then, reciprocally, radiation from a radiation source located, (or apparently located), at the receiver can conversely be scanned, by the same operation of the scanning apparatus, over the object to be imaged, so that, at any instant, the part of the image being illuminated can also be the part being “viewed” by the receiver. It will be appreciated that such an arrangement may be realized by using a beam splitter or the like arrangement which may be employed to bring the path of the beam from the illumination source, and the line of sight of the radiation receiver, into alignment. FIG. 7 illustrates schematically one way in which such an arrangement may be realized. Thus, referring to FIG. 7, a scanning device illustrated schematically at 106 operates to scan object 102 and to direct radiation from the scanned object 102 to a stationery radiation receiver 108 along a substantially fixed line of sight 110. A beam splitter 112 is interposed between the receiver 108 and the scanning apparatus 106 and allows radiation to pass from the scanner 106, along the line of sight 110, to the receiver 108 through the beam splitter, whilst also serving to reflect a beam of radiation from the illumination source 114 to the scanner along line of sight 110. Although such an arrangement is not essential, it does make it possible to illuminate only the portion of the object being imaged at the respective instant. This reduces the power requirement for the illumination source and/or reduces the number illumination sources required. In arrangements in which the scanning apparatus in the imaging device feeds two or more radiation receivers simultaneously, (so that each radiation receiver contributes a respective sub-raster to the overall scan), a respective illumination source may be associated with each radiation receiver, in the manner described above.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

1. A method of illuminating subjects to be imaged by a microwave, millimetre wave, sub-millimetre wave or infrared passive imaging system, comprising directing onto the subject to be imaged, the image or shadow of a cold source, i.e. a source with a low black body temperature, or of a hot source, i.e. a source with a black body temperature significantly higher than that of the subject to be imaged.

2. A method according to claim 1 wherein said cold source or hot source is incorporated in said imaging system and uses at least part of the imaging system which is adapted to receive imaging radiation from the scene or subject being imaged to direct said image or shadow of the cold or hot source onto the scene or subject being imaged.

3. Imaging apparatus for passive microwave, millimetre wave, sub-millimetre wave or infrared imaging, including a receiver for microwave, millimetre wave or infrared radiation from the scene or subject being imaged, directing means for directing such radiation onto the receiver, a cold source or a hot source, i.e. a source with a low or high black body temperature, and means for directing the image or shadow of said cold source or hot source onto the scene or subject being imaged.

4. Apparatus according to claim 3 wherein said directing means for directing radiation from the source or subject being imaged onto said receiver forms, at least in part, part of said means for directing said image or shadow from said cold source or hot source.

5. Apparatus according to claim 4 wherein said image or shadow of said cold source or hot source is directed onto the scene or subject being imaged, and radiation from said scene or subject is directed onto said receiver, via a conventional circulator, or via a wire grid polariser and quarter wave reflector or transmitter in combination, or via a wire grid polariser and a Faraday rotator.

6. A method of illuminating subjects to be imaged by a microwave, millimetre wave, sub-millimetre wave or infrared passive imaging system, substantially as, hereinbefore described, with, reference to FIG. 1 or FIG. 2 of the accompanying drawings.

7. Apparatus according to claim 3 and substantially as hereinbefore described with reference to FIG. 1 or FIG. 2 of the accompanying drawings.

8. A method of illuminating an object by radiation in the microwave, millimetre wave, sub-millimetre wave or infrared ranges for imaging by an imaging device, comprising arranging a retroreflector facing the object and disposed laterally with respect of the line of sight between the object and the imaging device and directing such radiation onto the object, from a radiation source, along a path corresponding to or close to said line of sight, whereby light from said source, reflected laterally from the object, will be reflected, in turn, by the retroreflector, back substantially along the path which it followed from the object to the retroreflector, to be reflected in turn, by the object, back to the imaging device.

9. A method according to claim 8 wherein the retroreflector comprises a cube-corner reflective array.

10. A method according to claim 8 wherein the retroreflector comprises a layer of transparent beads, spheres or lenses.

11. A method according to claim 8 wherein the retroreflector comprises a cube-corner reflector array in combination with an array of converging lenses arranged over the corner array, each lens covering or substantially covering a respective cube-corner of the array.

12. A method according to any of claims 8 to 11 wherein the imaging device is arranged to scan the object in a scanning raster and wherein the radiation from said source is directed onto the object in a beam which is caused to scan the object in a corresponding scanning raster such that the instantaneous path of the beam of said radiation from said source to the object corresponds substantially to the instantaneous line of sight from the imaging device to the object.

13. Apparatus for illuminating and imaging an object in an object area by radiation in the microwave, millimetre wave, sub-millimetre wave or infrared ranges, comprising an imaging device, a source of such radiation, a retroreflector arranged facing said object area and means for directing such radiation from the radiation source towards said object area along a path corresponding to the line of sight of the imaging device.

14. Apparatus according to claim 13 wherein the retroreflector comprises a reflective cube-corner array.

15. Apparatus according to claim 13 wherein the retroreflector comprises a cube-corner reflective array in combination with an array of converging lenses arranged over the cube-corner array, each lens covering or substantially covering a respective cube-corner of the array.

16. Apparatus according to any of claims 13 to 15 wherein the imaging device is arranged to scan the object area in a scanning raster and said means for directing is arranged to direct a beam of such radiation, from said source, towards the object area and to scan the beam in corresponding raster over the object area, such that the instantaneous path of the beam of said radiation from said source to the object area corresponds substantially to the instantaneous light of sight from the imaging device to the object area.

17. A method according to claim 8 and substantially as hereinbefore described with reference to FIGS. 3 to 5 of the accompanying drawings.

18. Apparatus according to claim 13 and substantially as hereinbefore described with reference to and as shown in FIGS. 3 to 5 of the accompanying drawings.
